(19) United States
(12) Patent Application Publication
(10) Pub. No.: US 2001/0056406 A1
(43) Pub. Date: Dec. 27, 2001

(54) Information processing apparatus and storage medium storing programs for controlling the apparatus

(76) Inventors: Kenji Nagoya, Tokyo (JP); Junichi Miyata, Kanagawa (JP)

Correspondence Address: ROBIN BLECKER & DALEY, 2ND FLOOR, 330 MADISON AVENUE, NEW YORK, NY, 10017, US

(21) Appl. No.: 09/879,730

(22) Filed: Jun. 12, 2001

(30) Foreign Application Priority Data
Jun. 20, 2000 (JP) 185183/2000
Jun. 20, 2000 (JP) 185184/2000
May 8, 2001 (JP) 137312/2001

(51) Int. Cl. G06F 17/60

(52) U.S. Cl. 705/52

(57) ABSTRACT

In outputting data by using another apparatus connected to a network, an output charge for output data can be calculated without sending the output data to the network.

### BACKGROUND OF THE INVENTION

1. Field of the Invention

The present invention relates to an information processing apparatus capable of outputting data by using another apparatus connected to the network, and to a storage medium storing programs for controlling the information processing apparatus.

2. Related Background Art

Print services whose printout is charged to a company or to each department are used nowadays. In this case, it is important to show a charge per each printout to users before actually charging the users. In an environment with a graphic user interface such as Windows generally used presently, a printout application uses a predetermined API (application programming interface) to call a printer driver and generate output commands.

Although such API can designate general items such as the direction and size of sheets, other items can only be designated by driver-specific user interface. For example, if designation of items which influence the calculation of charge, such as staple and N-UP, is used, the printout application cannot collect charges set before printing and cannot notify the user of the charges.

Japanese Patent Application Laid-Open Nos. 9-130573, 10-20957 and 11-134057 realize a charge notice before printing in which a host transmits print data and print setting to another apparatus such as a server and the other apparatus calculates a print charge and notifies the host of this print charge.

Japanese Patent Application Laid-Open Nos. 9-130573, 10-20957 and 11-134057 are, however, associated with the following problems. In order to confirm the charge before printing, it is necessary to transmit print data and print setting even if the user does not print it out because of the notified charge. A load of the network is therefore increased.

Further, if the size of print data and print setting to be transmitted is large, it takes a long time until the charge is notified.

Furthermore, since the other apparatus calculates a charge, it takes some time until the charge is notified.

### SUMMARY OF THE INVENTION

It is an object of the invention to allow a printout charge to be notified to a user without giving a load on the network.

It is another object of the invention to quickly notify a user of a printout charge.

It is still another object of the invention to allow a user to make output cancellation, alteration and the like while achieving the above objects.

It is a further object of the present invention to automatically cancel a printout process depending upon a notified output charge.

The above and other objects of the present invention will become apparent from the following detailed description of embodiments when read in conjunction with the accompanying drawings.

### BRIEF DESCRIPTION OF THE DRAWINGS

FIG. 1 is a diagram showing the overall system structure according to an embodiment of the invention.

FIG. 2 is a block diagram showing the structure of each apparatus according to the embodiment of the invention.

FIG. 3 is a memory map of a print-related module including an application loaded in RAM 2 of a host computer 3000 and a printer driver with a charge processing function, according to first and second embodiments.

FIG. 4 is a block diagram illustrating the structure of a print-related module with a charge processing function according to the first and second embodiments.

FIG. 5 is a flow chart illustrating the operation of the first embodiment.

FIG. 6 is a flow chart illustrating the outline of the application according to the second embodiment.

FIG. 7 is a flow chart illustrating the outline operation of the driver according to the second embodiment.

FIG. 8 is a flow chart illustrating the detailed operation at Step 503 shown in FIG. 7 according to the second embodiment.

FIG. 9 is a memory map of a host computer 3000 according to a third embodiment.

FIG. 10 is a memory map of a print server 5000 according to the third embodiment.

FIG. 11 is a block diagram of a charge processing module running on the host computer 3000 according to the third embodiment.

FIG. 12 is a block diagram of a printer driver running on the host computer 3000 according to the third embodiment.

FIG. 13 is a block diagram of a printer driver running on the print server 7000 according to the third embodiment.

FIG. 14 is a diagram showing an example of a charge database managed by a database management application according to the third embodiment of the invention.

FIG. 15 is a flow chart illustrating the operation of the host computer 3000 according to the third embodiment.

FIG. 16 is a diagram showing an example of charge attribute information according to the third embodiment.

FIG. 17 is a diagram showing an example of charge attribute information according to the third embodiment.

FIG. 18 is a diagram showing charge attribute information with the page number attribute incremented by 1 according to the third embodiment.

FIG. 19 is diagram showing charge attribute information with the page number attribute incremented by 12 according to the third embodiment.

FIG. 20 is a diagram showing a job information file according to the third embodiment.

FIG. 21 is a flow chart illustrating the operation of a charge application according to the third embodiment.

FIG. 22 is a diagram showing a charge database bundled in the charge application according to the third embodiment.

FIG. 23 is a diagram showing a confirmation dialog when a job is transmitted according to the third embodiment.

FIG. 24 is a flow chart illustrating the operation of a print server 7000 according to the third embodiment.

FIG. 25 is a flow chart illustrating the operation of a host computer 3000 according to a fourth embodiment.

FIG. 26 is a diagram showing charge attribute information according to the fourth embodiment.

FIG. 27 is a diagram showing a page layout setting dialog for making a user forcibly set a page layout according to the fourth embodiment.

FIG. 28 is a diagram showing a setting dialog for making a user forcibly set one-sided/both-sided print according to the fourth embodiment.

FIG. 29 is a diagram showing a job information file printed out according to the fourth embodiment.

FIG. 30 is a flow chart illustrating an operation of a charge application according to a fifth embodiment of the invention.

FIG. 31 is a diagram showing charge information displayed by the charge application according to the fifth embodiment.

FIG. 32 is a diagram showing a print setting change user interface displayed by the charge application according to the fifth embodiment.

FIG. 33 is a diagram showing a job information file with changed print setting according to the fifth embodiment.

FIG. 34 is a diagram showing a charge information user interface with changed print setting according to the fifth embodiment.

FIG. 35 ia a diagram showing a print setting user interface displayed to a user by a printer driver UI unit according to a sixth embodiment.

FIG. 36 ia a diagram showing a print setting user interface displayed to a user by a printer driver UI unit according to the sixth embodiment.

### DETAILED DESCRIPTION OF THE PREFERRED EMBODIMENTS

Embodiments of the invention will be described with reference to the accompanying drawings.

### First Embodiment

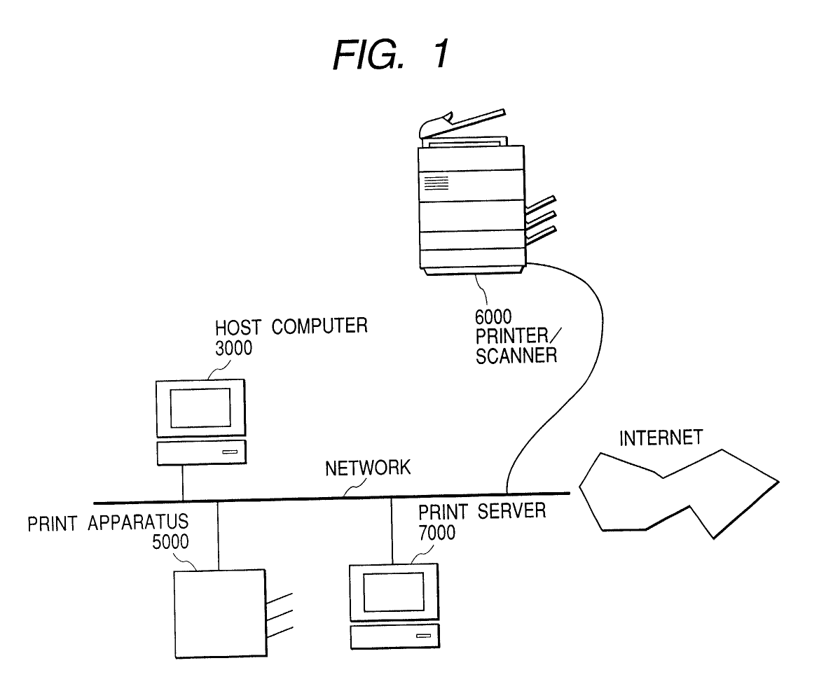

FIG. 1 is a diagram showing the overall system structure according to an embodiment of the invention. A host computer 3000 is connected via a network to a printer 5000, a composite machine 6000 with scanner and printer functions, and a print server 7000 for controlling transmission of a print job to the printer 5000 and composite machine 6000. Although not shown, it is obvious that the printer 5000, composite machine 6000 and print server 7000 may be connected to the Internet to which the host computer 3000 is connected.

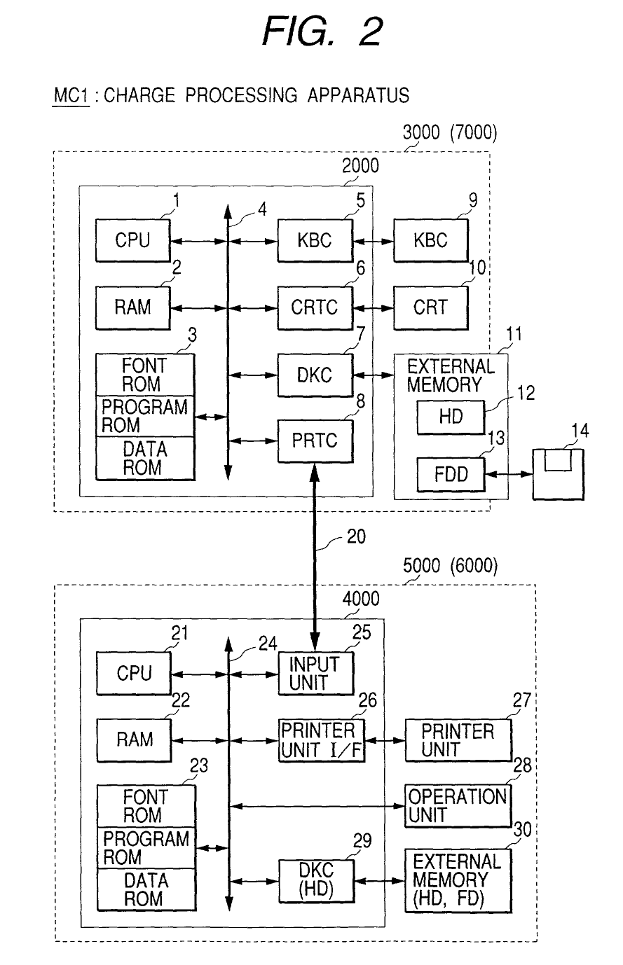

FIG. 2 is a block diagram showing the structures of the host computer 3000 and printer 5000 same as those of the print server 7000 and composite machine 6000, respectively.

Referring to FIG. 2, the host computer 3000 has a CPU 1 which processes a document mixed with figures, images, characters, tables (including spreadsheets) and the like in accordance with a document program or the like stored in a program ROM in a ROM 3. CPU 1 collectively controls each device connected to a system bus 4.

The program ROM in ROM 3 or an external memory 11 stores an operating system program (hereinafter called an “OS”) which is a control program of CPU 1. A font ROM in ROM 3 or the external memory 11 stores font data and the like to be used for the document processing. A data ROM in ROM 3 or the external memory 11 stores various data (such as directory data and a printer driver table) to be used for the document processing and the like.

The main control subject is CPU in terms of hardware, whereas in terms of software, the main control subject is a print-related module with an application and a charge processing function.

A RAM 2 is used as a main memory, working area and the like of CPU 1. A keyboard controller (KBC) 5 controls a key input from a keyboard 9 and an unrepresented pointing device. A display controller (CRTC) 6 controls a display of a CRT display (CRT) 10. A disk controller (DKC) 7 controls access to the external memory 11 such as a hard disk (HD) 12 and a floppy disk (FD) 14 set in a floppy disk drive (FDD) 13, the external memory 11 storing a boot program, various applications, font data, user files, edit files, print-related processing programs and the like.

A printer controller (PRTC) 8 is connected to the printer 5000 and composite machine 6000 via a predetermined bidirectional interface 20 and print server 7000.

CPU 1 can realize WYSIWYG (What You See Is What You Get) on CRT 10 by executing a development process (rasterizing process) of outline fonts onto, for example, a display data RAM in RAM 2. CPU 1 also executes various data processing by opening registered various dialogues by using each command designated by an unrepresented mouse cursor on CRT 10.

In the printer 5000, a printer CPU 21 outputs image signals and printout data to a printer unit (printer engine) 27 connected to a system bus 24, in accordance with a control program and the like stored in a program ROM in a ROM 23 or in an external memory 30. The program ROM in ROM 23 also stores a control program or the like of CPU 21.

A font ROM in ROM 23 stores font data and the like to used for creating output data. A data ROM in ROM 23 stores data and the like to be used by the host computer, if the printer does not have the external memory 30 such as a hard disk.

CPU 21 can communicate with the host computer 3000 via an input unit 25 to notify data and the like in the printer to the host computer.

A RAM 22 is used as the main memory, working area and the like of CPU 21 and can increase its capacity by an optional RAM connected to an unrepresented expansion port. RAM 22 is used as a printout data development area, an environment data storage area, an NVRAM and the like.

Access to the external memory 30 such as a hard disk (HD) and an IC card is controlled by a disk controller (DKC) 29. The external memory 30 is connected as an optional device and stores font data, emulation programs, form data and the like. An operation unit 28 has switches, LED displays and the like.

The external memory is not limited only to one, but a plurality of external memories, two or more, may be connected such as an optional font card in addition to the built-in fonts and external memories storing programs for analyzing printer control languages of different language systems. The external memory may have an unrepresented NVRAM which stores printer mode setting data entered from the operation unit 28.

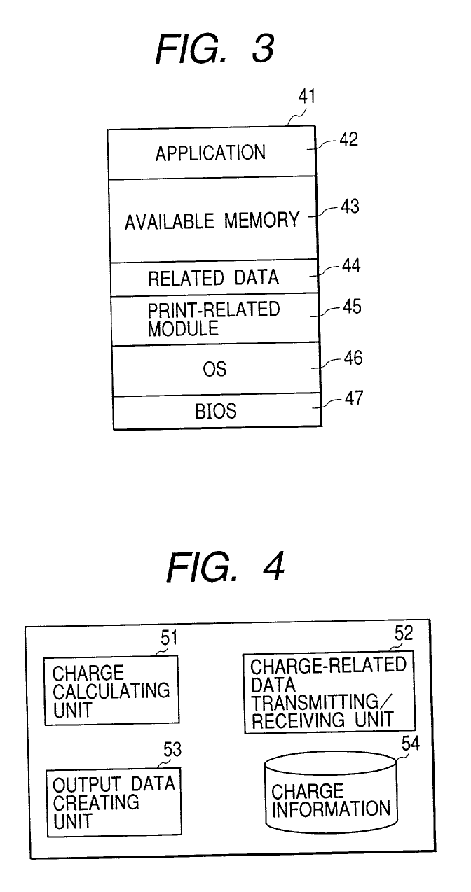

FIG. 3 is a memory map of a print-related module including an application loaded in RAM 2 and a printer driver with a charge processing function, the module having been made executable under the management of OS of the host computer 3000.

FIG. 4 is a block diagram showing the structure of the print-related module with the charge processing function according to the embodiment.

The print-related module includes: an output data creating unit 53; charge information 54 as the basis of calculating a charge; a charge-related data transmitting/receiving unit 52 for receiving charge-related information from an application and returning charge information to the application; and a charge calculating unit 51 for calculating a charge in accordance with the charge information and charge-related data received from the application.

Next, the operation of this embodiment will be described.

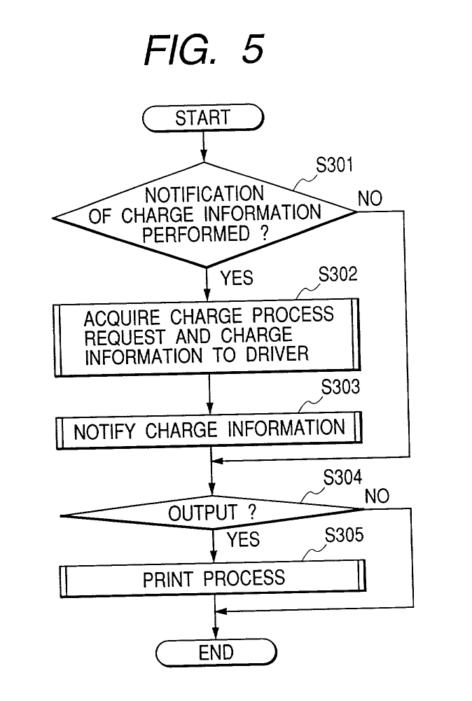

FIG. 5 is a flow chart illustrating the operation of the embodiment. A program for the flow chart shown in FIG. 5 is stored in HD 12 or FD 14 of the host computer 3000 and is executed by CPU 1 under the control of OS 46.

In this embodiment, the host computer 3000 operates while CPU 1 executes the print-related module having a BIOS, an OS, an application and a charge processing function. BIOS is written in the program ROM 3 and OS is written in the hard disk (HD) 12 as the external memory 11. When the power of the host computer 3000 is turned on, OS is read from HD to RAM 2 and starts running by an IPL (Initial Program Loading) function of a BIOS program.

When a print process is executed by an application running on the host computer 3000 under the OS management in response to an instruction from a user or the like, or when the print process is called from the application, the print-related module stored in FD 14 and set to FDD 13 or the print-related module stored in the HD drive 12 is read from FD 14 or the HD drive 12 and loaded in RAM 2. At this time, the print-related module with the charge processing function becomes actually executable.

FIG. 3 is a memory map of the print-related module with the application and charge-related processing function, the module being loaded in RAM 2 of the host computer 3000 and made executable, according to the embodiment. In this example, it is assumed that 2in1 is set (data of two pages is reduced to print it on one sheet) as the charging attribute which influences charge calculation and that the charge depends only upon the number of printed sheets. However, other charging attributes such as color, black-and-white, and staple may also be used. The application has the following four functions capable of being set by a user:

charge information is notified to a user and printout is not executed;

charge information is not notified to a user and printout is executed;

charge information is notified to a user and printout is executed after charge confirmation by the user; and

charge information is notified to a user and printout is not executed or canceled after charge confirmation by the user.

Referring to FIG. 5, the application judges whether charge information is to be notified to the user (Step 301). If the charge information is not to be notified, the flow advances to Step 304, whereas if to be notified, the flow advances to Step 302. At Step 302, charge-related data is supplied to a driver for controlling the printer 5000 and composite machine 6000 to ask the driver to calculate a charge, and to receive the calculated charge. This driver is an expandable interface or a dedicated interface.

In this case, in the called driver, the charge calculating unit 51 calculates a charge in accordance with the print data, charge information 54 as the basis of charge calculation, and driver setting such as a print layout (2in1) received at the charge-related data transmitting/receiving unit 52.

In the example described earlier, the application supplies the total number of logical pages. In the driver, in accordance with the total number of logical pages received at the charge-related data transmitting/receiving unit 52, driver setting, and charge information 54 including the number of output sheets and a unit charge, the charge calculating unit 51 calculates a charge, and the charge-related data transmitting/receiving unit 52 notifies the calculated result to the application.

Next, at Step 303, the application notifies the user of the charge calculated by the driver. If it is judged at Step 304 that printout is to be executed, the flow advances to Step 305 whereat print data is supplied to the print server 7000 and a print process accompanied with charging is executed at the printer 5000 and composite machine 6000 to thereafter terminate the flow. If it is judged at Step 304 that printout is not necessary, the flow is terminated.

Printout may be canceled if the charge notified at Step 303 exceeds a preset upper limit of charge.

In this embodiment, the application can acquire charge-related data which is still not charged to a user, without transmitting print data to the network. Therefore, various processes suitable for a charge can be performed, such as a notice of a charge from the application, printout after charge confirmation by a user, printout cancellation after charge confirmation by a user, printout cancellation if the charge exceeds an available upper limit money.

### Second Embodiment

In this embodiment, the application notifies the driver that a charge is required to be calculated, and thereafter executes a process similar to a usual printout to make the driver calculate a charge.

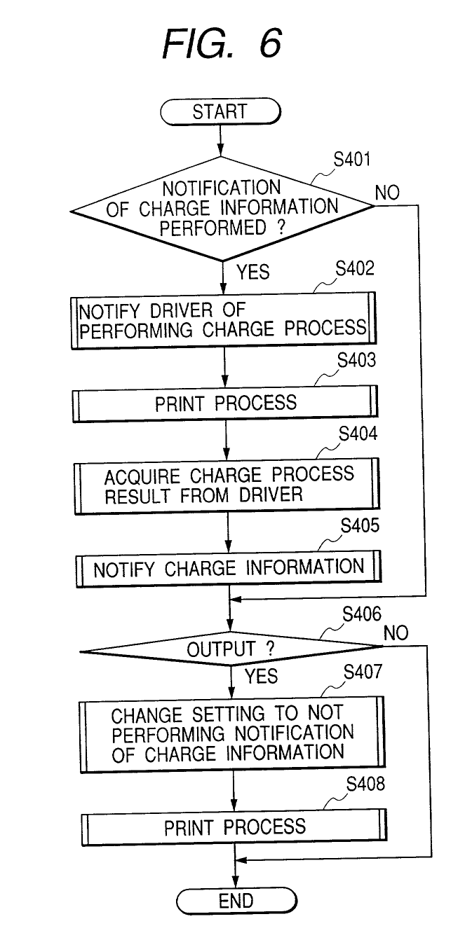

FIG. 6 is a flow chart illustrating the operation of an application according to the second embodiment.

Referring to FIG. 6, it is judged at Step 401 whether charge information is to be notified to a user. If not, the flow advances to Step 406. If charge information is to be notified to the user, the flow advances to Step 402. At Step 402, charge-related data is supplied to a driver for controlling the printer 5000 and composite machine 6000 to ask the driver to calculate a charge. This driver is an expandable interface or a dedicated interface.

Next, at Step 403 the application executes a print process similar to a usual printout such as supplying print data to the driver, so as to make the driver be capable of calculating a charge. At next Step 404, the application acquires the charge information calculated by the driver, and at Step 405 notifies the acquired charge information to the user. If it is judged at next Step 406 that printout is to be executed, at Step 407 setting is changed so that the charge information is not notified. Then, print data is supplied to the print server 7000 and a print process accompanied with charging is executed at the printer 5000 and composite machine 6000 to thereafter terminate the flow. If it is judged at Step 406 that printout is not necessary, the flow is terminated.

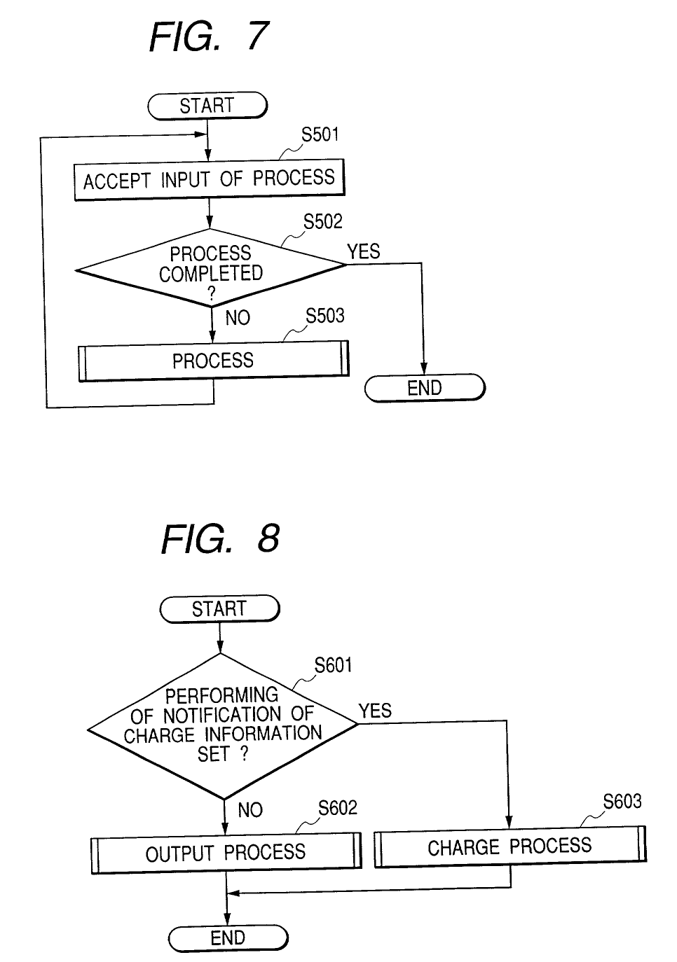

FIG. 7 is a flow chart illustrating the outline operation of the driver according to the second embodiment.

The operation of the driver called when the application executes the print process at Step 403 or 408 is illustrated in FIG. 7. An input of the process is accepted at Step 501, it is judged at Step 502 whether the process is completed, and if completed, the flow is terminated. If the process is not completed, the flow advances to Step 503 whereat the process to be described with FIG. 8 is executed to thereafter return to Step 501.

FIG. 8 is a flow chart illustrating the detailed operation at Step 503.

The detailed operation at Step 503 is illustrated in FIG. 8. It is judged at Step 601 whether setting is to notify charge information. If the setting is to notify charge information, a charge process is executed at Step 603 for calculating a charge for actual printout and notifying the charge to the application to thereafter terminate the flow. If setting is not to notify the charge, the print process is executed at Step 602 to thereafter terminate the flow.

Also in this embodiment, the application can acquire charge-related data which is still not charged to a user, without transmitting print data to the network.

### Third Embodiment

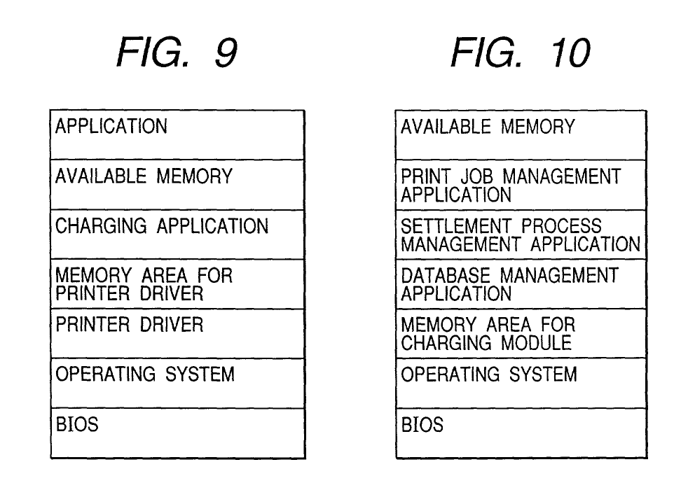

FIG. 9 is a memory map of a print-related module having an application, a printer driver and a charge application of the embodiment, the module being loaded in RAM 2 of a host computer 3000 under an OS management and made executable.

FIG. 10 is a memory map of a database management application, a settlement process management application and a print job management application of the embodiment, the applications being loaded in RAM 2 of a print server 7000 under an OS management and made executable.

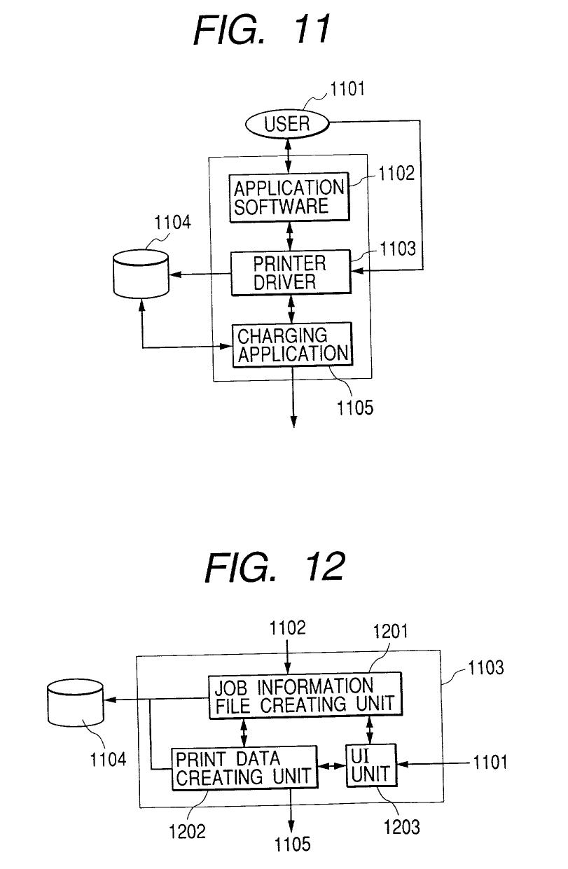

FIG. 11 is a block diagram showing the structure of a print-related module with a charge processing function of the host computer 3000 according to the embodiment. A user 1101 requests a print process through an application 1102 which is activated by a user to generate print data. A print driver 1103 generates a job information file and print data recognizable by a printer of this embodiment, in response to a drawing request from the application via an OS (not shown). A storage area 1104 stores the job information file and print data output from the printer driver 1103. A charge application 1105 is used for showing charge information to a user and transmitting the print data and job information file of this embodiment to the print server 7000.

The print-related module program shown in FIG. 11 is stored in an HD 12 or an FD 14 of the host computer 3000 and executed by a CPU 1 under an OS management. In this embodiment, the host computer 3000 operates while CPU 1 initiates a BIOS, OS, application, printer driver and charge application. BIOS is written in a program ROM 3 and OS is written in a hard disk 12 as an external memory 11. When the power of the host computer 3000 is turned on, OS is read from HD to RAM 2 and starts running by an IPL (Initial Program Loading) function of a BIOS program. When a print process is executed by an application running on the host computer 3000 under the OS management in response to an instruction from a user or the like, or when the print process is called from the application, the print-related module stored in FD 14 and set to FDD 13 or the print-related module stored in the HD drive 12 is read from FD 14 or the HD drive 12 and loaded in RAM 2. At this time, the print-related module with the charge processing function becomes actually executable. FIG. 9 is the memory map of the print-related module having an application and a charge processing function of the embodiment, the module being loaded in RAM 2 of a host computer 3000.

FIG. 12 is a diagram showing the structure of the printer driver 1103. The printer driver is constituted of a job information file creating unit 1201, a print data creating unit 1202 and a UI unit 1203. The job information file creating unit 1201 creates and stores a job information file including charge information and the like in the storage area 1104, with respect to drawing data requested from the application to print it out. The print data creating unit 1202 converts the drawing data requested from the application to print it out into print data recognizable by the printer and stores the converted print data in the storage area 1104. The UI unit 1203 is a user interface allowing a user to designate Nin1 such as 4in1 (data of 4 pages is reduced to be printed out on one physical sheet) which influences total charge calculation, or to designate a function of the print data creating unit 1202 such as a both-sided print.

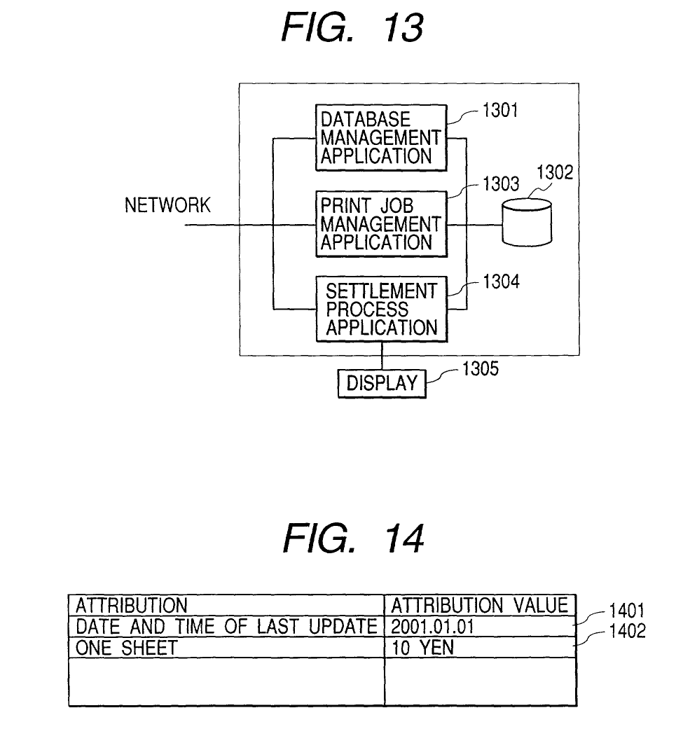

FIG. 13 is a block diagram showing the structure of a print-related module with a charge processing function of the print server 7000 according to the embodiment. A database management application 1301 provides a charge database stored in an internal storage area 1302 in response to a client request for acquiring the latest charge database. A print job management application 1303 spools print jobs of clients for the transmission of the print jobs to the printer 5000. A settlement process application 1304 provides a user with a user interface for a settlement process. FIG. 14 is a diagram showing an example of the structure of the charge database possessed by the database management application 1301. A field 1401 stores a date and time when the charge database was lastly updated. A field 1402 stores a charge for each current charge element. In this embodiment, it is assumed that only “one sheet” is defined as the charge element and the charge is 10 Yen.

The print-related module program shown in FIG. 13 is stored in HD 12 or FD 14 of the print server 7000 and executed by CPU 1 under the OS management. In this embodiment, the print server 7000 operates while CPU 1 initiates the BIOS, OS, and related applications. BIOS is written in the program ROM 3 and OS is written in a hard disk 12 as an external memory 11. When the power of the print server 7000 is turned on, OS is read from HD to RAM 2 and starts running by an IPL (Initial Program Loading) function of a BIOS program. When the print-related module with the charge processing function is called by an instruction of a user or the like, the print-related module stored in FD 14 and set to FDD 13 or the print-related module stored in the HD drive 12 is read from FD 14 or the HD drive 12 and loaded in RAM 2 under the control of OS and BIOS. At this time, the print-related module with the charge processing function becomes actually executable. As described earlier, FIG. 10 is the memory map of the print-related module with the charge processing function of the embodiment loaded in RAM 2 of the print server 7000 and made executable.

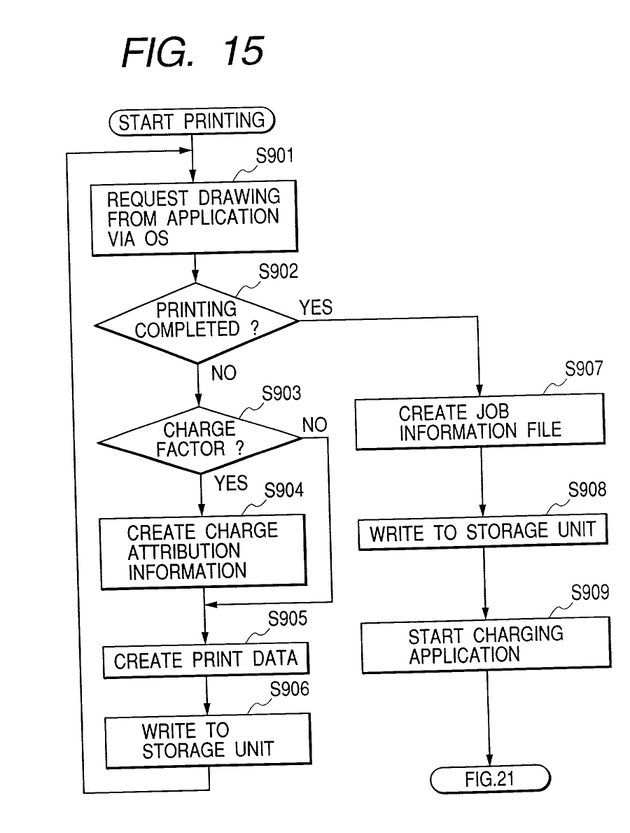

Next, the details of the embodiment will be described with reference to the flow chart of FIG. 15. In this embodiment, it is assumed that a user prints data of 12 pages by using the application 1102. It is also assumed that as the printer driver setting which influences charge calculation, 4in1 (data of 4 pages is reduced to be printed out on one physical sheet) and both-sided print are set beforehand to the print data creating unit 1202 via the UI unit 1203 by a user. It is also assumed that the charge depends upon only the number of printed physical sheets. It is obvious that other print elements such as color, black-and-white, staple and the like may be taken into consideration for calculating the charge.

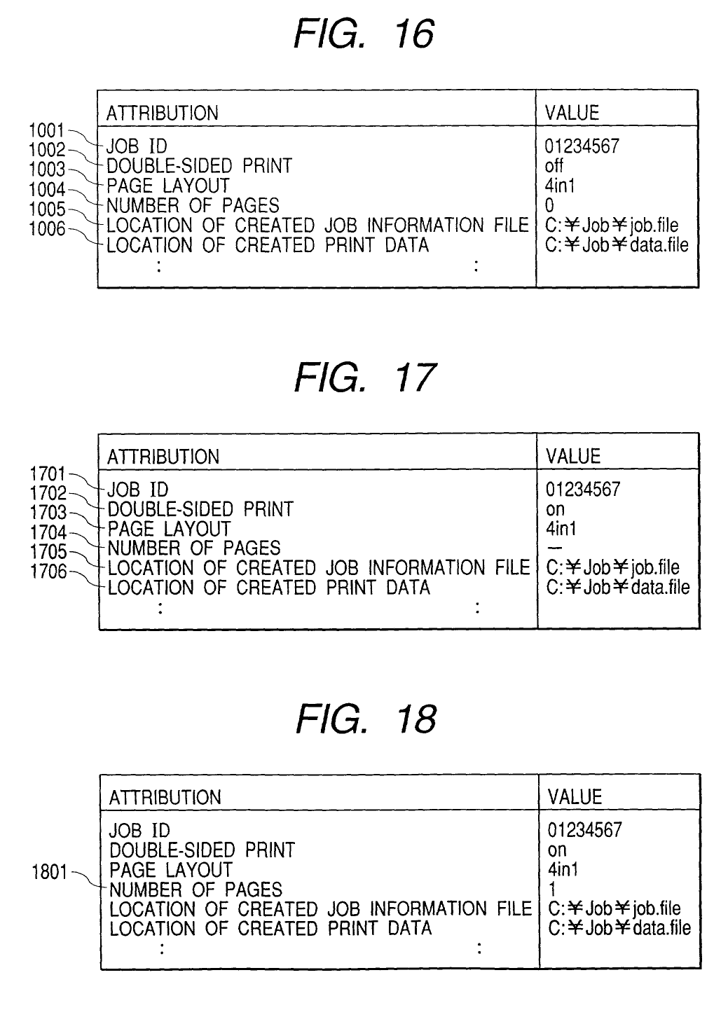

When the application starts a print process in response to a user instruction, a drawing request is issued from an operation system (OS) to the printer driver. This drawing request is received by the job information creating unit 1201 of the printer driver (S901). At S902 it is judged whether the drawing request is a print completion request. If it is not the print completion request, the flow advances to S903 whereat it is judged whether the drawing request contains a print element which influences the charge. If the drawing request contains the print element which influences the charge, then at S904 a charge attribute creating process is executed. The charge attribute created at S904 is stored in the printer driver and used as a reference database when the job information file is created. FIG. 16 shows an example of the structure of the charge attributes. In this embodiment, defined as the attributes which influence the charging process are a job ID 1001, a both-sided print 1002, a page layout 1003, the number of pages 1004, a location of a created job information file 1005 and a location of created print data 1006. It is assumed that the location of the created job information file 1005 and the location of created print data 1006 are stored as default values when the printer driver is initialized.

At S905 the drawing request is converted into print data recognizable by the printer. At S906, the print data is written in the storage area 1104 at the location of created print data 1006. If the print completion request is not received at S902, then at S907 the job information file creating unit 1201 creates a job information file from the charge attribute information shown in FIG. 16, and outputs at S908 the job information file to the location of the created job information file 1005. After the printout is completed, the print data creating unit activates the charge application 1105 at S909.

For a further specific example of this embodiment, it is assumed that the number of printed physical sheets influences the total charge and that a print job start request StartJob( ), a page start request StartPage( ), a drawing process request WritePage( ) and a print job end request EndJob( ) are passed to the printer driver as the drawing requests for printing data of 12 pages. It is assumed herein that the print job start request StartJob( ) and print job end request EndJob( ) are each issued once at the print start and end times and that the StartPage( ) and WritePage( ) are each issued once for each page. Therefore, each of these requests is issued twelve times in total to the printer driver.

When the print process starts, i.e., when OS issues the print job start request StartJob( ), the job information creating unit receives this drawing request (S901). Since this drawing request is not the print job end request, the flow advances to S903 whereat it is judged whether the drawing request contains an element which influences the charge. Assuming in this embodiment that the charge setting (4in1 print, both-sided print) set by the user at the print start time is reflected upon the charge attributes, it is judged that this drawing request influences the charge so that at S904 the charge attribute creating process is executed. FIG. 17 shows an example of the charge attributes created in this case. At the print process start, the job ID 1701, both-sided print 1702, page layout 1703, location of created job information file 1705 and location of created print data 1706 are set as the charge attributes. These attribute values are independent from the drawing request from OS and are stored at the print process start. If the job ID is an unique value for all prints, it may be determined by OS or by the printer driver. The location of the created job information file and the location of the created print data are representative of particular files managed in the whole print system.

The print job start request is converted into the print data at S905, and output to a particular area indicated by the location of the created print data 1706 at S906. Also at S906 the print data creating unit embeds the job ID 1701 in the print data at an optional location.

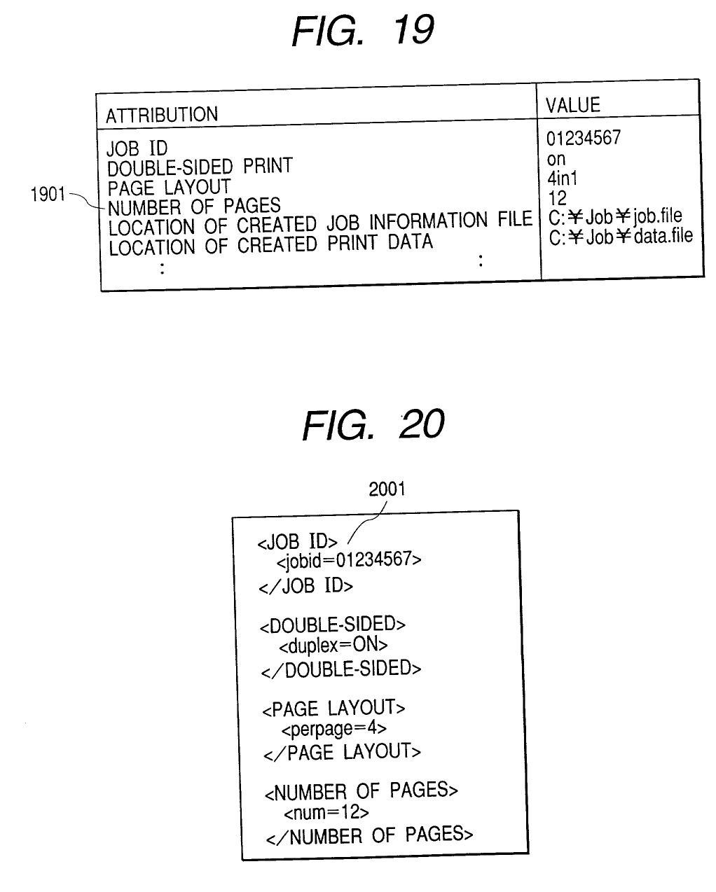

Next, OS issues the page start request StartPage( ). The job information creating unit receives this drawing request (S901). Since this drawing request is not the print job end request, the flow advances to S903 whereat it is judged whether the drawing request contains an element which influences the charge. Since the page start request influences the number of physical sheets, it is judged that the page start request influences the charge so that the charge attribute creating process is executed at S904. FIG. 18 shows an example of the charge attributes changed in this case. The field 1801 of the number of pages is incremented by 1. This page start request is converted into print data and output to the area indicated by the location 1706. Next, OS issues a page drawing process request WritePage( ). The page drawing process request may be an image drawing request, a vector drawing request, a font print request or the like. In this embodiment, it is judged that these requests do not influence the charge information creation so that the page drawing request is converted into print data at S905 and output at S906 to the location 1706. This sequence is repeated the number of pages. Namely, the drawing requests of StartPage( ), WritePage( ) and EndPage( ) are repeated thereafter twelve times. FIG. 19 shows the charge attribute information after the sequence is repeated twelve times. The page number field 1901 was incremented twelve times and the attribute value became 12.

Lastly, OS issues the print job end request EndJob( ). The job information creating unit receives the drawing request at S901. Since this drawing request is a print job end request, the flow advances to S907 whereat the job information creation unit outputs the job information file created from the charge attribution information created at S907 to the particular area indicated by the location 1706. FIG. 20 shows an example of a job information file created in this case. Reference numeral 2001 represents an ID (identifier) of the job information file uniquely determined for each print job. This job ID gives one-to-one correspondence between the actual print data and corresponding job information file. As described earlier, the same job ID 2001 is embedded in the output print data file at an optional location.

After the job information file is created, the print data creating unit 1202 activates the charge application at S909. The charge application may be made to be activated by OS at the print end time. When the charge application is activated, the print data creating unit notifies the charge application of the location of the created job file 1705 and the location of the created print data 1706.

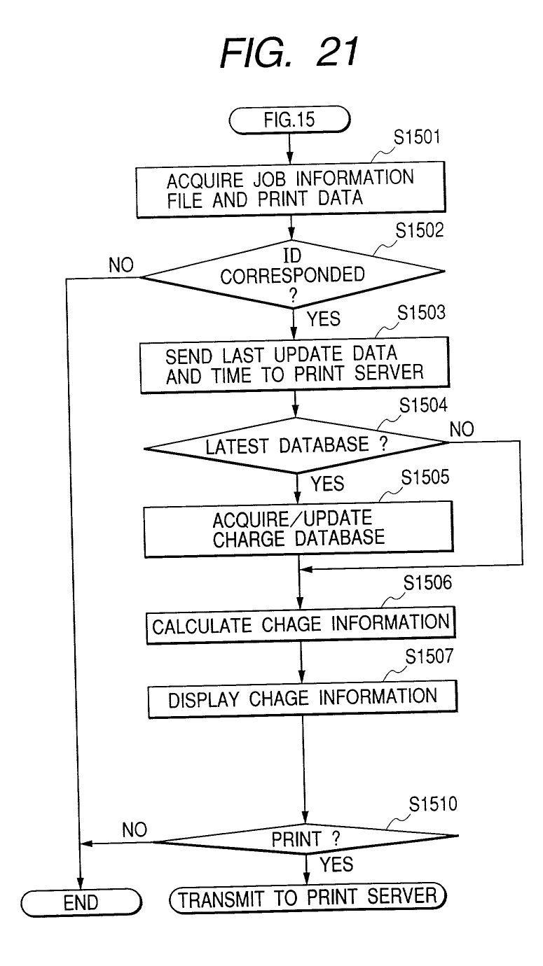

The operation after the charge application is activated is shown in the flow chart of FIG. 21.

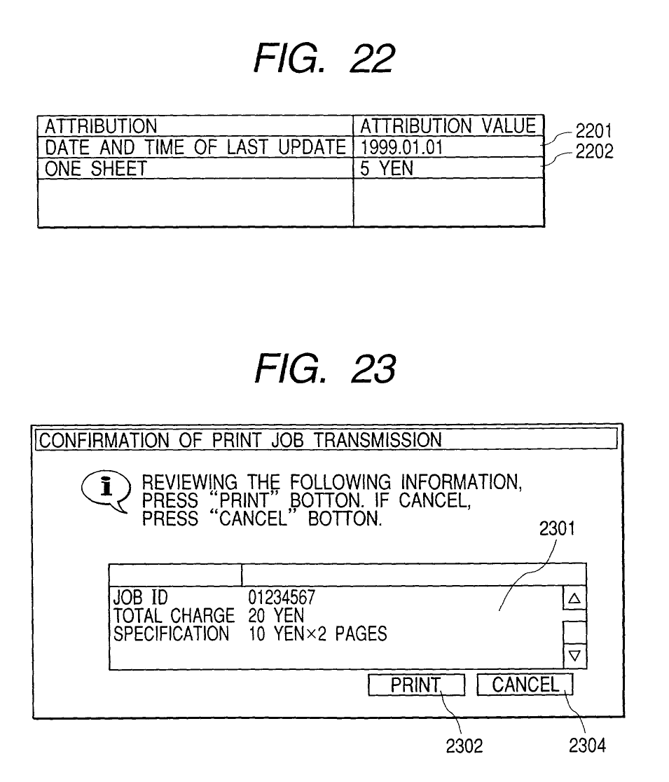

In this embodiment, it is assumed that the charge application has a charge database such as shown in FIG. 22 stored in the storage area 504. A field 2201 stores the date and time of last update of the charge database. In this embodiment, the data “1999.01.01” is set to this field 2201. A field 2202 stores a charge for each charge element. In this field, an attribute value “5 Yen” is set for the attribute “one sheet”.

The charge application acquires the job information file and print data file created by the printer driver from the locations notified by the print data creating unit 1105 (S1501). At S1502, the job ID in the print data is compared with the job ID in the job information file. If it is confirmed that both the IDs are the same, the charge application inquires the print server 7000 about the charge. For this inquiry, the date and time of last update 2201 of the charge database is first notified to the print server (S1503). Upon reception of this notice, the database management application 1301 of the print server checks whether the notified date and time is older than the data and time of last update stored in the charge database in the print server shown in FIG. 14. If older. the charge application is notified that the update is necessary. If the notified date and time is the same as the data and time of last update stored in the charge database, the charge application is notified that update is not necessary. If it is judged at S1504 that the charge database is to be updated, the charge application received this notice issues a latest database acquisition request to the print server. Upon reception of this request, the database management application transmits the database shown in FIG. 14 to the charge application. The charge application acquired the latest database updates the internal charge database stored as shown in FIG. 22 to make it have the contents shown in FIG. 14. In this embodiment, the date and time in the server side charge database is 2001.01.01 and the date and time in the client side charge database is 1999.01.01. Therefore, with this sequence, the client side charge database is updated as shown in FIG. 14. Next, the charge application calculates the charge by using the charge database and job information file (S1506). In this embodiment, the data to be charged is the number of printed physical pages actually printed out. Therefore, it is judged that a charge of 10 Yen is added per one printed physical sheet. The number of physical pages on which print data of 12 pages is printed from the job information file is two when considering the 4in1 print, so that the total charge of 10×2=20 Yen is calculated at S1506. Information including the total charge and the specification of the charge obtained from the job information file is displayed to the user at S1507. FIG. 23 shows an example of the user interface used for displaying such information. In this user interface (UI unit), a field 2301 displays job information and charge information to the user. If the user depresses a print button 2302 in this UI unit (S1510), the charge application transmits the print data and job information file to the print server 7000. If the user depresses a cancel button 2303 (S1510), the print operation is canceled.

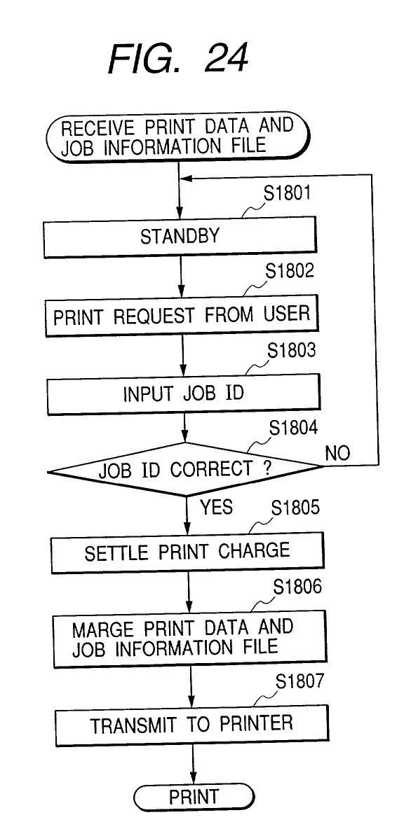

The process of the print server 7000 received the print data and job information file will be described with reference to the flow chart of FIG. 24.

The print job application 1303 of the print server 7000 received the job information and print data stores the received job information and print data in the internal memory 1302. The print job management application stands by without starting the print process until the user supplies a printout request (S1801). After the user supplies the printout request (S1802), the user inputs the job ID on the display 1305 of the print server (S1803). If the settlement process application 1304 judges that the input job ID is correct (S1804), the user is judged as the user who sent the print data and the settlement process for printout is executed (S1805). Thereafter, the print job management application merges data of the job information file such as both-sided print associated with printout, into print data recognizable by the printer (S1806). This merge process is a process of converting an entry such as the both-sided print described in the job information file into control languages recognizable by the printer. Thereafter, the print data is transmitted to the printer 5000 to complete the print process (S1807). The printer 5000 prints out the print data supplied from the print server 7000.

### Fourth Embodiment

Only different points of the fourth embodiment from the third embodiment will be described. In the fourth embodiment, setting of the attributes which influence the charge and entered by the user before printout via the UI unit 1203 of the printer driver, is forcibly entered by the user during printout. With the fourth embodiment, it is possible to make the user reliably set the attributes which influence the charge.

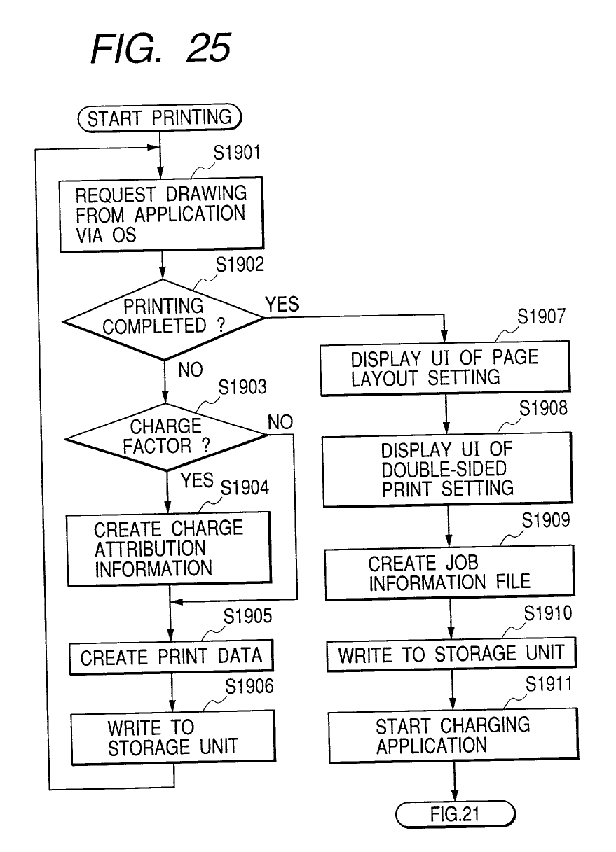

The flow chart of this embodiment is shown in FIG. 25.

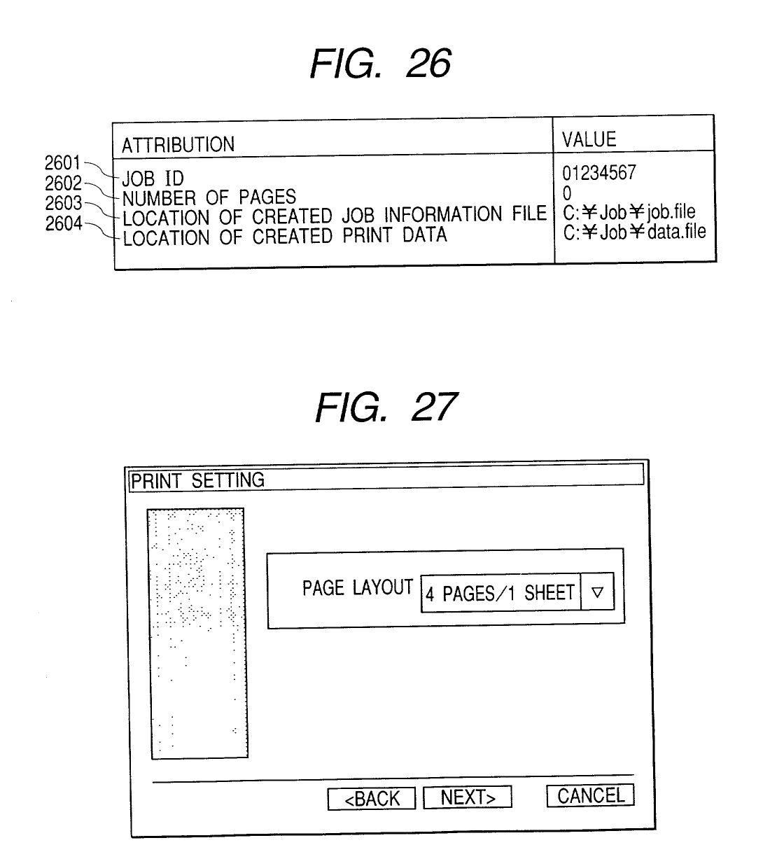

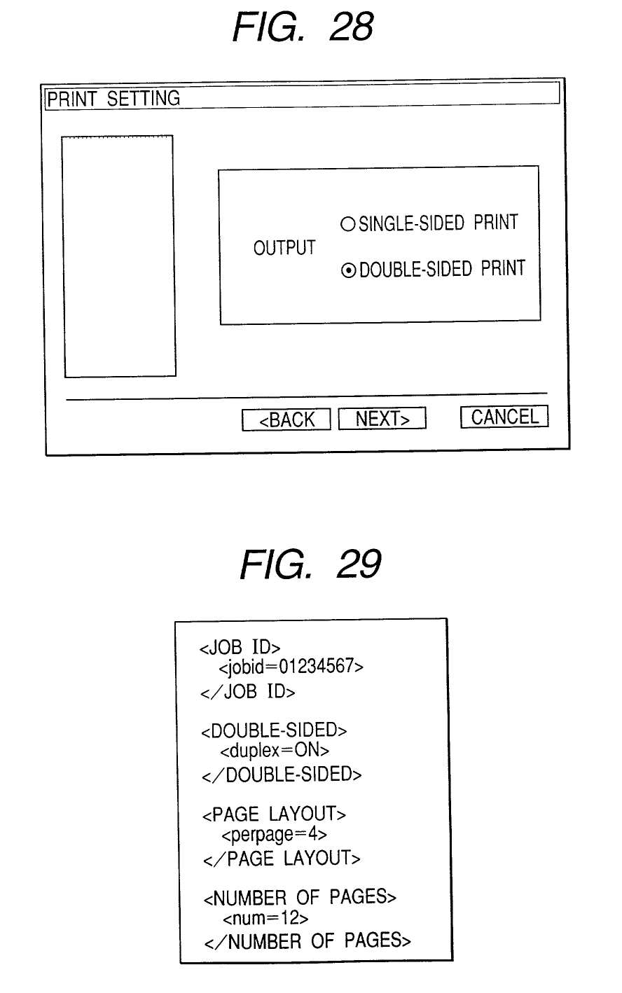

After the application starts printout in response to a user instruction, OS (operating system) issues a drawing request to the printer driver and the job information creating unit 601 receives this drawing request (S1901). At S1902 it is checked whether the drawing request is a print job end request. If it is not a print job end request, the flow advances to S1903 whereat it is checked whether the drawing request contains any attribute which influences the charge. If the drawing request influences the charge, a charge attribute creating process is executed at S1904. It is assumed that the charge attribute to be created at S1904 is stored in the printer driver and used as the reference database for creating a job information file. FIG. 26 shows an example of the structure of the charge attributes. The page layout and both-sided print taken into consideration in the third embodiment are not considered at this time. In this embodiment, a job ID 2601, the number of pages 2602, a location of a created job information file 2603 and a location of created print data 2604 are defined as the attributes which influence the charge processing. It is assumed that the location of the created job information file 2603 and the location of created print data 2604 are stored as default values when the printer driver is initialized. At S1905 the drawing request is converted into print data recognizable by the printer. At S1906, the print data is written in the storage area 1104 at the location of created print data 2604. If the print completion request is received at S1902, then at S1907 the job information file creating unit displays a dialog for forcibly making the user to set the page layout via the user interface. At S1908 the job information file creating unit displays a dialog for forcibly making the user to set the both-sided print via the user interface. FIGS. 27 and 28 show examples of the user interfaces displayed in this case. The job information creating unit creates a job information file by considering the setting (S1909), and outputs the job information file to the location of the created print data 2604 at S1910. FIG. 29 shows the job information file output in this case. After the printout is completed, the print data creating unit activates the charge application 1105 at S1911. The process to be executed after the charge application 1105 is activated is the same as the third embodiment, and the description thereof is omitted.

For a further specific example of this embodiment, it is assumed that the number of printed physical sheets influences the total charge and that a print job start request StartJob( ), a page start request StartPage( ), a drawing process request WritePage( ) and a print job end request Endjob( ) are passed to the printer driver as the drawing requests for printing data of 12 pages. It is assumed herein that the print job start request StartJob( ) and print job end request EndJob( ) are each issued once at the print start and end times and that the StartPage( ) and WritePage( ) are each issued once for each page. Therefore, each of these requests is issued twelve times in total to the printer driver.

When the print process starts, i.e., when OS issues the print job start request StartJob( ), the job information creating unit receives this drawing request (S1901). Since this drawing request is not the print job end request, the flow advances to S1903 whereat it is judged whether the drawing request contains an element which influences the charge. Assuming in this embodiment that only the job ID, location of the created job information file, and location of the created print data are reflected upon the charge attributes at the print start time, it is judged that this drawing request influences the charge so that at S1904 the charge attribute creating process is executed. FIG. 26 shows an example of the charge attributes created in this case. If the job ID is an unique value for all prints, it may be determined by OS or by the printer driver. The location of the created job information file and the location of the created print data are representative of particular files managed in the whole print system.

The print job start request is converted into the print data at S1905, and output to a particular area indicated by the location of the created print data 2604 at S1906. Also at S1906 the print data creating unit embeds the job ID 2601 in the print data at an optional location at the print start time.

Next, OS issues the page start request StartPage( ). The job information creating unit receives this drawing request (S1901). Since this drawing request is not the print job end request, the flow advances to S1903 whereat it is judged whether the drawing request contains an element which influences the charge. Since the page start request influences the number of physical sheets, it is judged that the page start request influences the charge so that the charge attribute creating process is executed at S1904. Next, OS issues a page drawing process request WritePage( ). The page drawing process request may be an image drawing request, a vector drawing request, a font print request or the like. In this embodiment, it is judged that these requests do not influence the charge information creation so that the page drawing process request is converted into print data at S1905 and output at S1906 to the location 2604. This sequence is repeated the number of pages. Namely, the drawing requests of StartPage( ), WritePage( ) and EndPage( ) are repeated thereafter twelve times. The page number attribute 2602 is incremented twelve times and the attribute value becomes 12.

Lastly, OS issues the print job end request EndJob( ). The job information creating unit receives the drawing request at S1901. Since this drawing request is a print job end request, the flow advances to S1907 whereat the job information creation unit displays a page layout dialog shown in FIG. 27 for forcibly making the user to set the page layout. At S1908 the job information file creating unit displays a setting dialog shown in FIG. 28 for forcibly making the user to set the both-sided print/one-sided print. Assuming in this embodiment that the user sets the 4in1 print and both-sided print, the job information creating unit creates a job information file from the setting and charge attribute information created at S1904, and outputs it to the particular area indicated by the location 2604. FIG. 29 shows an example of a job information file created in this case. After the job information file is created, the print data creating unit activates the charge application at S1911. The charge application may be made to be activated by OS at the print end time. When the charge application is activated, the print data creating unit notifies the charge application of the location of the created job file 2603 and the location of the created print data 2604. The succeeding sequence is similar to that of the third embodiment.

In this embodiment, the page layout and both-sided print are considered as the elements which influence the charge. It is obvious that other print elements such as color, staple and the like may be taking into consideration for calculating the charge.

As described so far, according to the third and fourth embodiments, with the process executed by the host computer, charge-related information can be displayed to a user without actual charge to the user, and the user can cancel the printout by referring to the supplied charge-related information. Since the print server managed by an administrator always manages the charge database, it is possible to always display the latest charge information to a user.

### Fifth Embodiment

In this embodiment, a user can change print setting after confirming the job information and charge information. In this embodiment, the operation to be executed before the charge application is activated is similar to the third embodiment, and the description thereof is omitted.

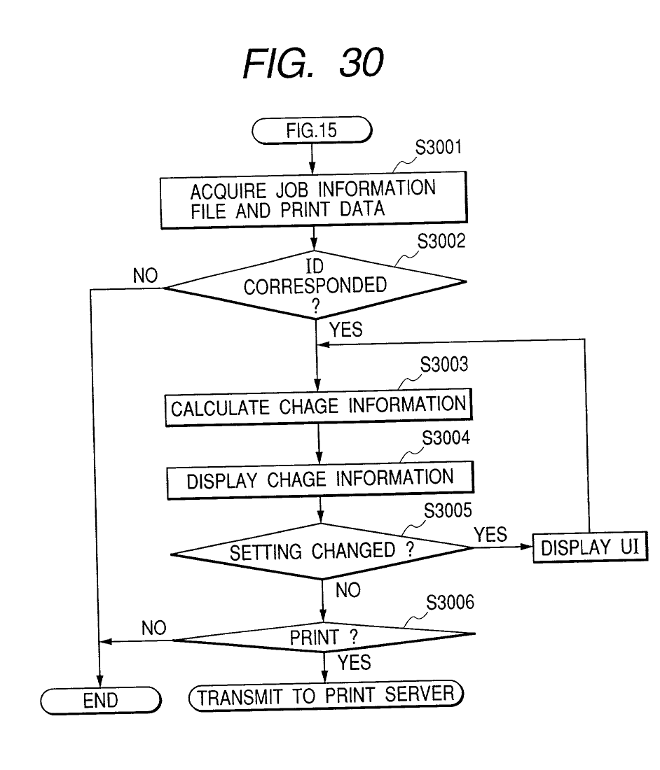

A flow chart after the charge application is activated is shown in FIG. 30.

The charge application acquires the job information file and print data file created by the printer driver from the locations notified by the print data creating unit (S3001). At S3002, the job ID in the print data is compared with the job ID in the job information file. If it is confirmed that both the IDs are the same, a charge is calculated in accordance with the job information file (S3003).

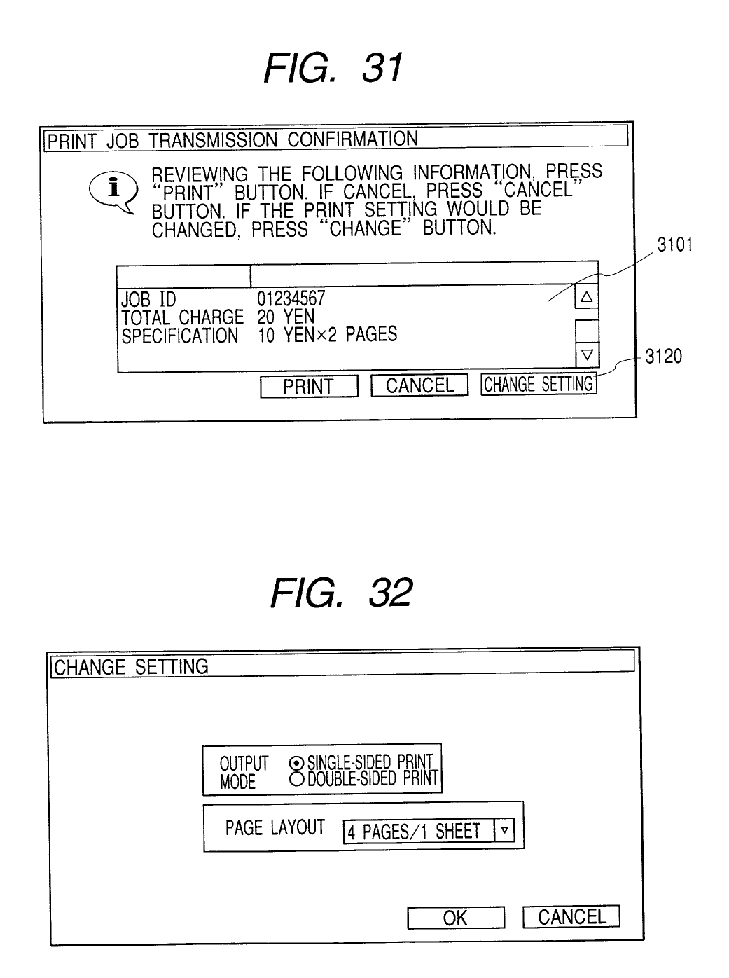

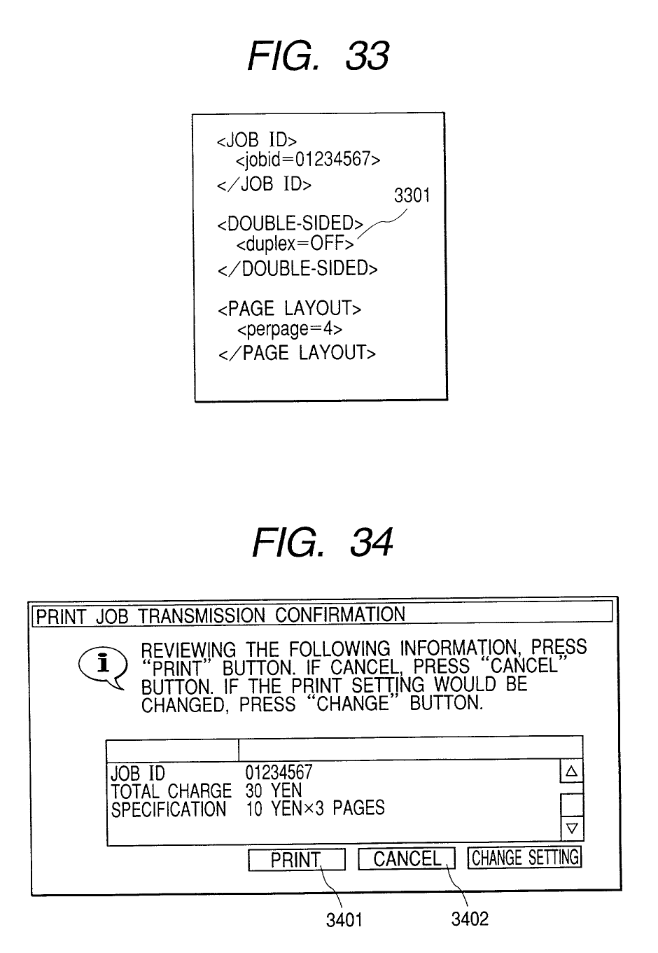

In this embodiment, the data to be charged is the number of printed physical pages actually printed out. Assuming that a charge of 10 Yen is added per one printed physical sheet and that the both-sided print and 4in1 print are set, the number of physical pages on which print data of 12 pages is printed is two, so that the total charge of 10×2=20 Yen is calculated at S3003. Information including the total charge and the specification of the charge obtained from the job information file is displayed to the user at S3004. FIG. 31 shows an example of the user interface used for displaying such information. In this user interface (UI unit), a field 3101 displays job information and charge information to the user. This field displays a current total charge, the specification for each setting, and the like. In this case, if the displayed charge information does not show a desired charge, the user can change the print setting by depressing a setting change button 3102. A user interface for changing the print setting is shown in FIG. 32. As shown in FIG. 32, if the user changes the setting from the both-sided print to one-sided print on the UI unit, the data of 12 pages is printed on three physical sheets so that the total charge is changed to 30 Yen. When the user depresses an OK button shown in FIG. 32, the charge information is changed. This change is reflected upon the job information file. The one-sided print is designated as indicated at 3301. The charge application replaces the entry of the corresponding job information file by the changed data. After this replacement, the user interface (UI unit) displayed at S3004 is displayed again as shown in FIG. 34. If the user depresses a print button 3401 on this UI, then the charge application transmits the job information file with the altered entry and the print data to the print server 7000. If the user depresses a cancel button 3402, the print operation is not performed.

The process by the print server received the print data and job information file is similar to that of the third embodiment (FIG. 24), and the description thereof is omitted.

### Sixth Embodiment

Different points of this embodiment from the other embodiments will be described. It is possible to provide beforehand a user with charge information matching print purposes by using the UI unit 1203 of the printer driver 1103.

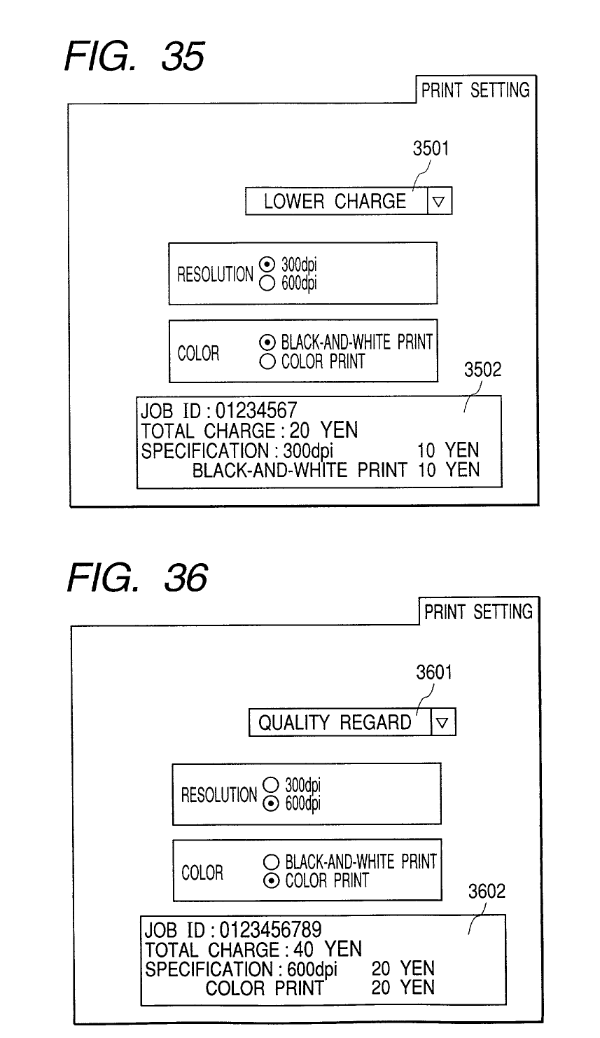

In this embodiment, it is assumed that printer driver setting which influences charge calculation includes a resolution (in this embodiment, either 600 dpi or 300 dpi is selectable) and color (color print or black-and-white print is selectable). It is also assumed that prior to the printout by the application, the UI unit of the printer driver can display a user interface such as shown in FIG. 35. A user is provided with setting abstracts 3501 so as to automatically set charge information. In this embodiment, either “lower charge” or “quality regard” can be selected, in the former, a printer driver is set to lower the charge and in the latter a print quality pays high regard. For example, if a user selects “lower charge” 3501, each setting value in UI is automatically changed as shown in FIG. 35. The “lower charge” setting shown in FIG. 35 selects a low resolution (300 dpi) and “black-and-white print” in order to lower the charge. If a user selects “quality regard” 3501, each setting value in UI is automatically changed as shown in FIG. 36. The “quality regard” setting shown in FIG. 36 selects a high resolution (600 dpi) and “color print” in order to improve the print quality.

In fields 3502 and 3602 on UI, charge information for setting values is displayed beforehand. In this embodiment, although “lower charge” and “quality regard” are set, it is obvious that other setting abstracts which influence charging system, such as “speed regard” and “2in1 print”, may also be used.

In each of the above-described embodiments, although FD or HD is used as the medium for storing the print-related module with an application program and charge processing function, other media such as a CD-ROM, an IC memory card, a network such as an e-mail and personal computer communications may also be used. The print-related module with an application program and charge processing function may be stored in ROM 3. In this case, this storage area is constituted as a part of a memory map and the module is directly executed by CPU 1.

As described so far, according to the fifth and sixth embodiments, with the process executed by the host computer, charge-related information can be displayed to a user without actual charge to the user, and the user can change print setting and print out with a charge desired by the user.

What is claimed is:

1. An information processing apparatus capable of outputting data by using another apparatus connected to a network, comprising:
creating means for creating setting information when data is output, during a predetermined process of making the output data recognizable by the other apparatus; and
calculating means for calculating an output charge in accordance with the created setting information,
wherein creating the setting information and calculating the output charge are performed before the output data is sent to the network.

2. An information processing apparatus according to claim 1, wherein calculation by said calculating means is performed by a control program for controlling the other apparatus.

3. An information processing apparatus according to claim 1, wherein generating the setting information is performed by a control program for controlling the other apparatus, and calculation by said calculating means is performed by a charge application which is activated by a process different from the control program.

4. An information processing apparatus according to claim 1, wherein whether calculation by said calculating means is performed and whether the output data is sent to the network after the calculation by said calculating means, is settable beforehand.

5. An information processing apparatus according to claim 1, wherein if the output charge calculated by said calculating means exceeds a predetermined value, the output data is not sent to the network.

6. An information processing apparatus according to claim 1, further comprising notifying means for notifying a user of the output charge calculated by said calculating means.

7. An information processing apparatus according to claim 6, further comprising means responsive to an operation by the user for terminating an output process without sending the output data to the network or for changing the setting information.

8. An information processing apparatus according to claim 7, wherein if the setting information is to be changed, information for making the user select either setting of charge regard or setting of output quality regard is notified to the user.

9. An information processing apparatus according to claim 1, wherein said calculating means calculates the output charge in accordance with charge information stored in the information processing apparatus.

10. An information processing apparatus according to claim 9, wherein the charge information is updated in accordance with information received via the network.

11. An information processing apparatus according to claim 1, wherein said creating means makes a user set information for the output data during executing the predetermined process.

12. A storage medium storing a program for controlling an information processing apparatus capable of outputting data by using another apparatus connected to a network, comprising:
a creating step of creating setting information when data is output, during a predetermined process of making the output data recognizable by the other apparatus; and
a calculating step of calculating an output charge in accordance with the created setting information,
wherein creating the setting information and calculating the output charge are performed before the output data is sent to the network.

13. A storage medium according to claim 12, wherein calculation by said calculating step is performed by a control program for controlling the other apparatus.

14. A storage medium according to claim 12, wherein generating the setting information is performed by a control program for controlling the other apparatus, and calculation by said calculating step is performed by a charge application which is activated by a process different from the control program.

15. A storage medium according to claim 12, wherein whether calculation by said calculating step is preformed and whether the output data is sent to the network after the calculation by said calculating step, is settable beforehand.

16. A storage medium according to claim 12, wherein if the output charge calculated by said calculating step exceeds a predetermined value, the output data is not sent to the network.

17. A storage medium according to claim 12, further comprising a notifying step of notifying a user of the output charge calculated by said calculating step.

18. A storage medium according to claim 17, further comprising a step, responsive to an operation by the user, of terminating an output process without sending the output data to the network or of changing the setting information.

19. A storage medium according to claim 18, wherein if the setting information is to be changed, information for making the user select either setting of charge regard or setting of output quality regard is notified to the user.

20. A storage medium according to claim 12, wherein said calculating step calculates the output charge in accordance with charge information stored in the information processing apparatus.

21. A storage medium according to claim 20, wherein the charge information is updated in accordance with information received via the network.

22. A storage medium according to claim 12, wherein said creating step makes a user set information for the output data during executing the predetermined process.
